(19) United States
(12) Patent Application Publication
(10) Pub. No.: US 2003/0175508 A1
(43) Pub. Date: Sep. 18, 2003

(54) Resealable multi-ply label

(76) Inventor: Joseph D. Franko SR., Ham Lake, MN (US)

Correspondence Address: NIKOLAI & MERSEREAU, P.A., 900 SECOND AVENUE SOUTH, SUITE 820, MINNEAPOLIS, MN, 55402, US

(21) Appl. No.: 10/099,669

(22) Filed: Mar. 14, 2002

(51) Int. Cl. B32B 7/12

(52) U.S. Cl. 428/354; 428/40.1; 428/343

(57) ABSTRACT

A resealable multi-ply label has a base ply having an under side and an upper side and an amount of an adhesive on the under side to attach the label to an object of interest to be labeled, an upper ply having an under side and an upper side wherein the upper side of the base ply and the under side of the upper ply are joined together along a hinge strip by an amount of a permanent adhesive material thereby forming a permanent hinge. The upper side of the base ply and the under side of the upper ply are releasably, resealably joined along at least a second edge spaced from the hinge strip using a release-reseal system including layers of a release material and a pressure sensitive adhesive such that the plies can be separated and resealed.

### BACKGROUND OF THE INVENTION

I. Field of the Invention

The present invention relates generally to the field of labeling and, in particular, the present invention provides a multi-ply resealable label construction that does not require a pressure sensitive adhesive hinge.

II. Related Art

Multi-ply labels, variously referred to as “mult-layered” “extended text,” or “expanded content” labels, are useful for consumer products, particularly those sold in bottles, cans and cartons, where it is desirable to present additional information to the consumer which cannot conveniently be contained on a single printed label surface. Particularly in view of the increasing amount of governmental regulation and labeling requirements, many consumer products contained in such packaging must carry additional information including detailed instructions for use, detailed listings of the contents, a variety of consumer product warnings, and provisions for multi-lingual information. This has led to the provision of multi-ply labels carrying text on a plurality of surfaces. Such labels normally contain two or more layers or plies of label material hinged together using a pressure sensitive adhesive along one margin and utilizing a pressure sensitive reseal system along the opposite margin. For example, Hill et al in U.S. Pat. No. 5,149,587 and Coward et al in U.S. Pat. No. 5,904,973 show label constructions of this type.

These labels normally are constructed utilizing a pair of label layers or plies with pressure sensitive adhesive therebetween to provide a hinge along one edge. The pressure sensitive adhesive, however, remains tacky and subject to being pulled apart by users of the label. Furthermore, pressure sensitive adhesive hinges are often compromised by environmental conditions (e.g., mechanical forces, humidity, temperature fluxuations, and age). This is particularly true if the hinge is a narrow strip. This has led to the use of rather wide hinge strips between label layers which reduces the available text area on inner surfaces.

Thus, it would present a distinct advantage if the pressure sensitive adhesive hinge could be replaced by a hinge in which the plies were joined at one margin in a manner which was permanent, less likely to be pulled apart, and not dependent upon the hinge width for its security. Of course, a smaller hinge also restores available copy area to the label plies.

### SUMMARY OF THE INVENTION

In accordance with the present invention, there is provided a resealable multi-ply label that includes a first or base ply having an under side and an upper side and an amount of a pressure sensitive adhesive on the under side to attach the label to an object of interest to be labeled. A second or upper ply is provided having an upper side and an under side and the upper side of the base ply and the under side of the upper ply are joined together permanently along a first or hinge edge or other hinge strip by an amount of a permanent adhesive material which is not pressure sensitive and which thereby forms a permanent hinge. Additional plies may be attached beneath the upper ply using a portion of the hinge strip.

The upper side of the base ply and the under side of the upper ply are also releasably, resealably, joined along an opposite or second edge or along an outer release-reseal margin opposite the hinge or at one or more release-reseal strips spaced from a central hinge strip (depending on the label configuration). A dual layer release-reseal system is used which includes a layer of pressure sensitive adhesive and an abutting layer (top/bottom) of a release material such that the plies can be separated and resealed at a juncture therebetween.

The permanent adhesive material of the hinge is preferably selected from adhesives including hot melt adhesives, solvent-based adhesives, water-based adhesives, and UV—(ultraviolet) and EB—(electron beam) curable adhesives. Herein, “permanent adhesive” may be defined to include any glues, non-pressure sensitive adhesive materials including but not limited to heat seal adhesives, and multiple part epoxies, chemical welding or bonding, and mechanical fastening means, that all achieve a desired result of securely bonding two plies together. It is to be particularly appreciated that a “permanent adhesive” is one that is tack-free in the cured or final adhesive state, in bonding plies together. Examples of preferred materials include UV-curable adhesives such as those available from RAD-CURE Corporation of Fairfield, N.J., including RAD-CURE 10PSLVA,B.

Preference of one such adhesive over another particularly will depend upon a drying or curing system of a given label manufacturing press, along with materials composition and compatibility considerations. In the dual layer reseal system, abutting layers may be applied to the plies in either order, either separately, or together as a combination on one of the plies. Thus, the pressure sensitive adhesive may be applied to the upper side of the base ply or to the under side of the upper ply and the release material may be applied on the whole of the opposite facing surface exclusive of the hinge area or a lesser area down to just as much of that surface as is covered by the pressure sensitive adhesive. The pressure sensitive adhesive also may be applied in an intermittent pattern along the opposite edge and also along the remaining opposed side edges, or in any other pattern if desired.

The release material may be a varnish, lacquer, or any other material (whether a coating or otherwise) which accomplishes the effect of a release medium and allows the pressure sensitive adhesive to adhere to it only lightly so that it may be peeled back and resealed. Additional label layers or plies may be added as required.

### BRIEF DESCRIPTION OF THE DRAWINGS

In the drawings wherein like numerals are utilized to designate like parts throughout the same:

FIG. 1a depicts a top view of a resealable, multi-ply label in accordance with the invention with an upper ply shown partially peeled back;

FIG. 1b depicts a view similar to that of FIG. 1a showing a modified embodiment;

FIGS. 2a and 2b depict cross-sectional views of alternate embodiments representative of either of the embodiments of FIGS. 1a and 1b; and

FIG. 2c is a view of an embodiment similar to that shown in FIG. 2b with an additional middle label ply.

FIGS. 3a and 3b depict yet another embodiment of a multi-ply label in accordance with the invention.

### DETAILED DESCRIPTION

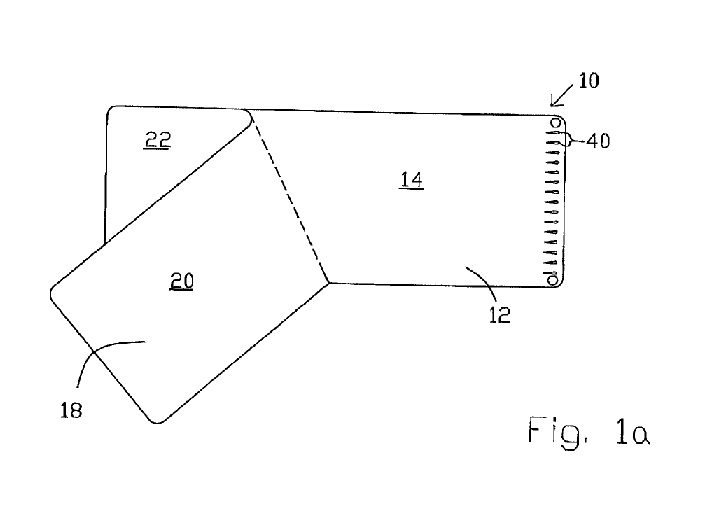

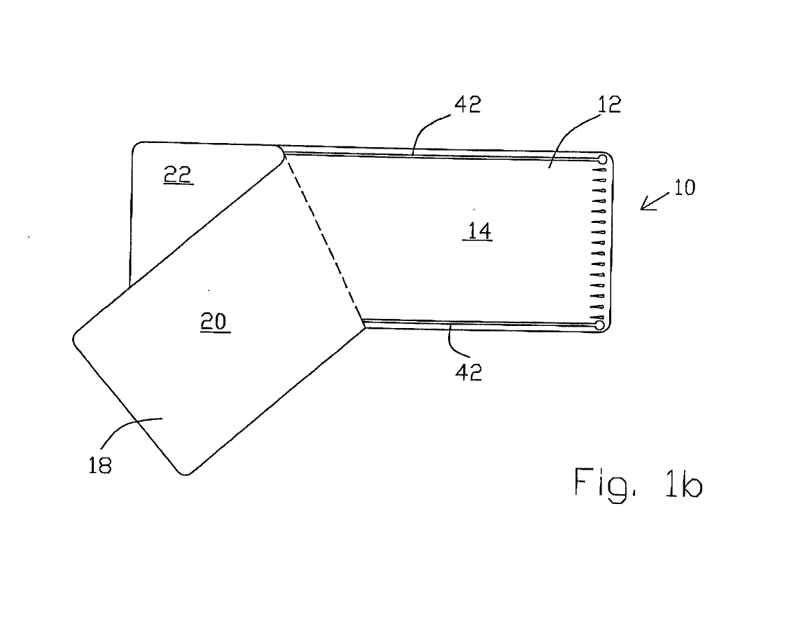

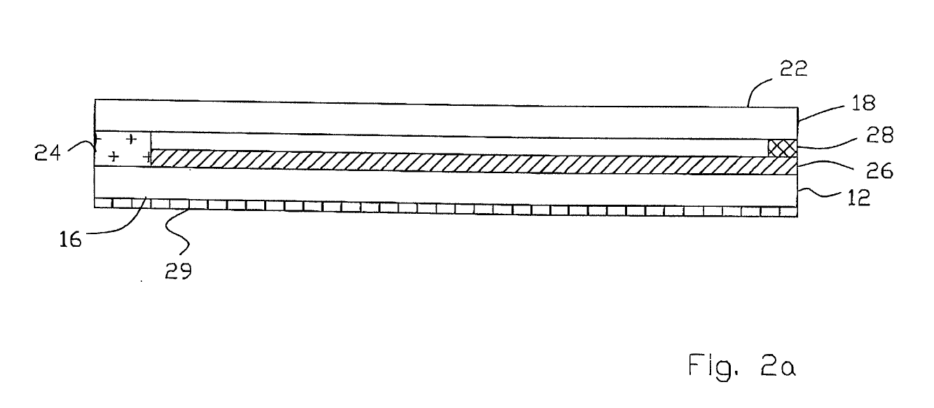

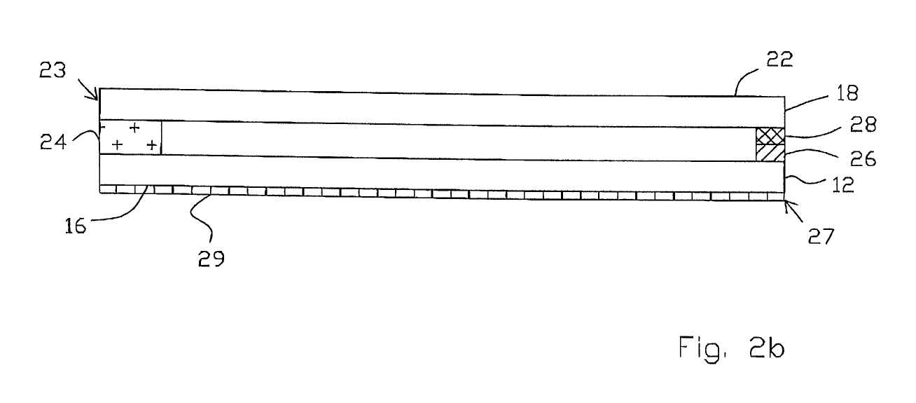

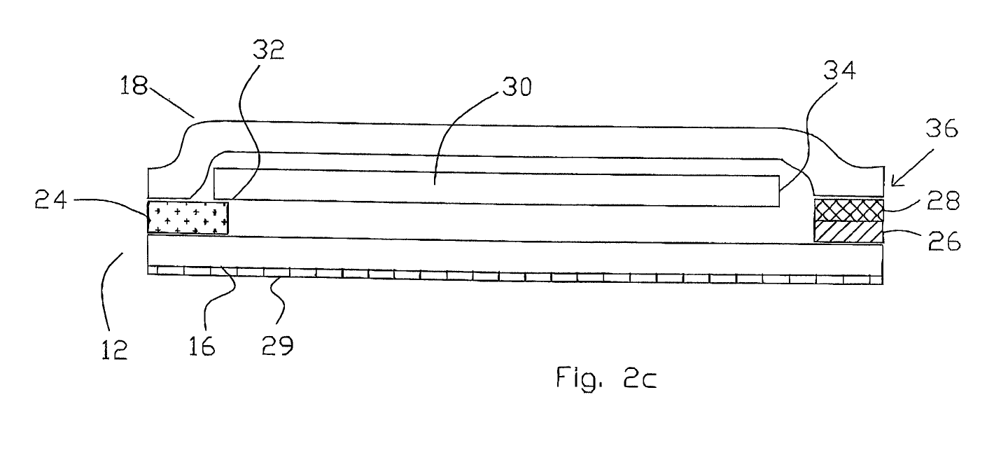

The detailed description contained herein in conjunction with the drawing figures presented is intended by way of example with respect to the inventive concept and not intended to be limiting in any way. With this in mind, FIGS. 1a and 1b show top views of a resealable, multi-ply label 10 having a first or base ply 12 having an upper side 14 and an under side 16 (FIGS. 2a-2c). Label 10 includes an upper or top ply 18 having an under side 20 and an upper side 22.

The plies 12 and 18 may be made of any suitable material that meets the physical and chemical compatibility requirements, along with desired aesthetic attributes and cost considerations, of a particular label. It is to be understood that where necessary, surfaces of the plies to be printed may receive one or more additional depositions of material to adjust the receptiveness to printing materials. Thus, an array of papers, plastics, and related materials may variously be employed for the plies, the surfaces of which may be adjusted as needed by those skilled in the art.

As best seen in FIGS. 2a-2c, the upper or top ply 18 is joined to the first or base ply 12 along a strip that is normally a hinge margin or edge 23 using a permanent adhesive material 24 to form a binding or hinge. The adhesive material 24 is designed to cause permanent adhesions so that the upper or top ply 18 resists unintentional peeling away and removal from label 10 as is the case with non-permanent or pressure sensitive adhesives often used in the hinged construction of such multi-ply labels. It is particularly to be noted that a consumer may, inadvertently, attempt to peel back or open a multi-ply label at an incorrect location. The permanent adhesive hinge will prevent an inadvertent splitting of the plies at the hinge.

As seen in FIGS. 1a-b and 2a-c, a portion of the upper side 14 of the first or base ply 12 is provided with a layer of release material 26 which may cover the entire area of the upper side 14 exclusive of regions having hinge adhesive material 24 as shown in FIG. 2a or some lesser amount as shown in FIGS. 2b and 2c. As used herein, ‘layer’ is intended to include any material applied by an suitable deposition technique such as coating, laminating, layering, and the like. The layer of release material 26 is typically a varnish, lacquer, ink, or other material that promotes high tack and low peel characteristics of the pressure sensitive adhesive. A layer of pressure sensitive adhesive is shown at 28 in FIGS. 2a-2c. This material in conjunction with the release material 26 enables release and resealing of the upper ply 18, and may be characterized, in combination, as a “release-reseal system”. A pattern of the pressure sensitive adhesive material in the release-reseal system may be continuous, or a discontinuous or intermittent pattern, it only being necessary that the pattern of the pressure sensitive adhesive be substantially aligned with the release material when the plies are sealed and that it provide sufficient tack to prevent unaided or unintentional opening of the label as may occur, for example, in a product labeling assembly line or on a retail shelf.

FIG. 2c depicts an alternate construction that adds a third or middle ply 30 between base ply 12 and upper or top ply 18. Middle ply 30 is also permanently hinged by the hinge adhesive material 24 along one edge at 32 and has free sides and a free end 34. End 34 terminates before reaching the pressure sensitive adhesive 28 of the release-reseal system so that it is captured within the label 10 when the top ply 18 is held closed by the release-reseal system.

As can be seen in the FIGS. 2b and 2c, the release-reseal system may be preferably limited to a vicinity of a second edge as at 36 which is opposite the hinge margin or hinge edge or strip 23. Of course, the release-reseal system requires only that the release material 26 be substantially aligned with the pressure sensitive adhesive 28 on the opposed surface of the adjacent ply.

As seen in FIGS. 1a and 1b, however, the pressure sensitive adhesive may be attached to the lower or base ply in an intermittent pattern along an edge as at 40 and along the two edges of remaining sides as at 42.

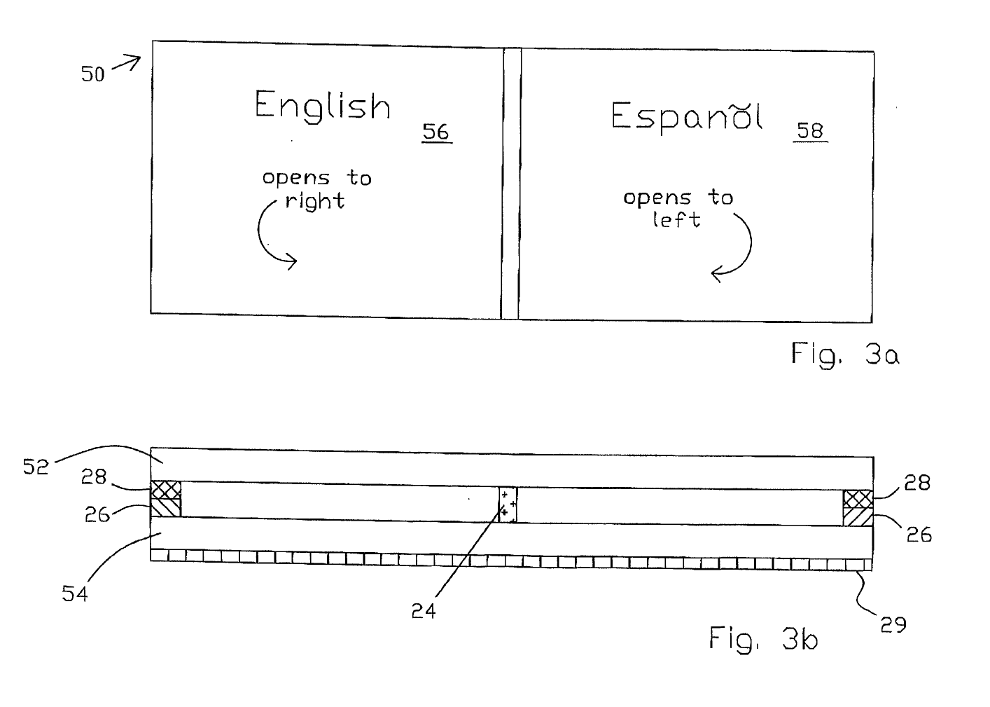

FIGS. 3a and 3b depict another embodiment which employs a center hinge of a permanent adhesive fixing, a central strip of an upper or top ply 52 to a central strip of lower or bottom ply 54 creating opposed leaves 56 and 58 which are releasably, resealably closed by systems similar to the previously described release-reseal systems. This enables, among other things, copy to be fully displayed in two languages, separate from each other.

Any of the labels may be provided, if desired, with an additional layer of adhesive 29 on the under or lower side of the base ply 12, 54 to attach the label to an object of interest to be labeled such as, for example, a bottle of a medicinal preparation or other health or beauty aid product. The label may be stored conveniently on a release paper (not shown) to protect the attachment surface.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. A resealable multi-ply label comprising:
(a) a base ply having an under side and an upper side and an amount of an adhesive on said under side to attach the label to an object of interest to be labeled;
(b) an upper ply having an under side and an upper side;
(c) an amount of a permanent adhesive material joining the upper side of said base ply and the under side of said upper ply together along a first edge thereby forming a hinge; and
(d) a release-reseal system comprising a layer of pressure sensitive adhesive and a layer of a release material substantially aligned when sealed with said pressure sensitive adhesive releasably, resealably joining the upper side of said base ply and the under side of said upper ply along a second edge opposite said first edge such that the plies can be separated and resealed at the juncture therebetween.

2. A resealable multi-ply label as in claim 1 wherein the permanent adhesive material of said hinge is selected from the group of adhesives consisting of hot melt adhesives, solvent-based adhesives, water-based adhesives and UV-curable and EB-curable adhesives.

3. A resealable multi-ply label as in claim 2 wherein said pressure sensitive layer of said release-reseal system is provided as a discontinuous pattern.

4. A resealable multi-ply label as in claim 2 wherein said release layer of said release-reseal system is provided on the upper side of said base ply.

5. A resealable multi-ply label as in claim 2 wherein said release layer of said release-reseal system is provided on the under side of said upper ply.

6. A resealable multi-ply label as in claim 1 wherein said release layer of said release-reseal system is substantially congruent with the said pressure sensitive adhesive layer thereof.

7. A resealable multi-ply label as in claim 3 wherein said release layer of said release-reseal system is provided on the upper side of said base ply.

8. A resealable multi-ply label as in claim 3 wherein said release layer of said release-reseal system is provided on the under side of said upper ply.

9. A resealable multi-ply label as in claim 2 wherein the area covered by said release layer of said release-reseal system extends beyond the area of said pressure sensitive adhesive layer.

10. A resealable multi-ply label as in claim 3 wherein the area covered by said release layer of said release-reseal system extends beyond the area of said pressure sensitive adhesive layer.

11. A resealable multi-ply label as in claim 9 wherein said release layer of said release-reseal system is applied to the upper side of said base ply.

12. A resealable multi-ply label as in claim 9 wherein said release layer of said release-reseal system is provided on the under side of said upper ply.

13. A resealable multi-ply label as in claim 10 wherein said release layer of said release-reseal system is applied to the upper side of said base ply.

14. A resealable multi-ply label as in claim 10 wherein said release layer of said release-reseal system is provided on the under side of said upper ply.

15. A resealable multi-ply label as in claim 1 wherein said release-reseal system includes pressure sensitive adhesive applied as an intermittent pattern.

16. A resealable multi-ply label as in claim 2 wherein material forming said hinge is UV-curable.

17. A resealable multi-ply label as in claim 1 wherein said release-reseal system is applied to edges of remaining sides of said label.

18. A resealable multi-ply label as in claim 2 wherein said release-reseal system is applied to edges of remaining sides of said label.

19. A resealable multi-ply label as in claim 1 further comprising a middle ply having an under side and an upper side disposed between said base ply and said upper ply the under side of said middle ply being joined to the upper side of said base ply along an edge thereof by said amount of permanent adhesive material thereby forming a hinge.

20. A resealable multi-ply label as in claim 19 wherein remaining edges of said middle ply are free edges.

21. A resealable multi-ply label comprising:
(a) a base ply having an under side and an upper side and an amount of an adhesive on said under side to attach the label to an object of interest to be labeled;
(b) an upper ply having an under side and an upper side;
(c) an amount of a permanent adhesive material selected from the group of adhesives consisting of hot melt adhesives, solvent-based adhesives, water-based adhesives and UV-curable and EB-curable adhesives joining the upper side of said base ply and the under side of said upper ply together along a first edge thereby forming a hinge; and
(d) a release-reseal system comprising an intermittent pattern of pressure sensitive adhesive and a layer of a release material aligned when sealed with said pressure sensitive adhesive releasably, resealably joining the upper side of said base ply and the under side of said upper ply along a second edge opposite said first edge such that the plies can be released and resealed at the juncture therebetween.

22. A resealable multi-ply label as in claim 21 further comprising a middle ply having an under side and an upper side disposed between said base ply and said upper ply the under side of said middle ply being joined to the upper side of said base ply along an edge thereof by said amount of permanent adhesive material thereby forming a hinge.

23. A resealable multi-ply label as in claim 22 wherein remaining edges of said middle ply are free edges.

24. A resealable multi-ply label as in claim 19 wherein said release-reseal system is applied to edges of remaining sides of said label.

25. A resealable multi-ply label comprising:
(a) a base ply having an under side and an upper side and an amount of an adhesive on said under side to attach the label to an object of interest to be labeled;
(b) an upper ply having an under side and an upper side;
(c) an amount of a permanent adhesive material joining the upper side of said base ply and the under side of said upper ply together along a first strip thereby forming a hinge therebetween; and
(d) at least one outer release-reseal margin spaced from said hinge comprising a layer of pressure sensitive adhesive and a layer of a release material aligned when sealed with said pressure sensitive adhesive releasably, resealably joining the upper side of said base ply and the under side of said upper ply at least one outer margin spaced from said hinge such that the plies can be separated and opened to said hinge and resealed at the juncture therebetween.

26. A resealable multi-ply label as in claim 25 including a pair of said release-reseal margins spaced from and flanking said hinge.

27. A resealable multi-ply label as in claim 26 wherein said hinge is at a midpoint of said base ply and said upper ply.

28. A resealable multi-ply label as in claim 25 wherein the permanent adhesive material of said hinge is selected from the group of adhesives consisting of hot melt adhesives, solvent-based adhesives, water-based adhesives and UV-curable and EB-curable adhesives.
